(19) United States
(12) Patent Application Publication
(10) Pub. No.: US 2023/0271252 A1
(43) Pub. Date: Aug. 31, 2023

(54) METAL DROP EJECTING THREE-DIMENSIONAL (3D) OBJECT PRINTER AND METHOD OF OPERATION FOR BUILDING SUPPORT STRUCTURES

(71) Applicant: Xerox Corporation, Norwalk, CT (US)

(72) Inventors: Collin A. Ladd, Charlotte, NC (US); Paul J. McConville, Webster, NY (US)

(21) Appl. No.: 17/652,914

(22) Filed: Feb. 28, 2022

(51) Int. Cl. B22F 10/22; B22F 12/50; B22F 12/00; B33Y 10/00; B33Y 30/00

(52) U.S. Cl. CPC B22F 10/22; B22F 12/50; B22F 12/22; B33Y 10/00; B33Y 30/00; B22F 2302/05; B22F 2302/256

(57) ABSTRACT

A three-dimensional (3D) metal object manufacturing apparatus is equipped with a borate solution application system to either build support structures with a borate solution containing silica particles or to apply such a borate solution to a surface of a metal support structure prior to manufacture of a metal object feature that is supported by the support structure. The silica particles in the borate solution structure form a glassy, brittle structure on which the metal object feature is formed. This glassy, brittle structure is removed relatively easily from the object after the object is manufactured.

### TECHNICAL FIELD

This disclosure is directed to three-dimensional (3D) object printers that eject melted metal drops to form objects and, more particularly, to the construction of support structures that enable overhang features and the like to be formed on the metal objects built in such printers.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers, while other technologies melt an elastomer and extrude the thermoplastic material into object layers. The printer typically operates one or more ejectors or extruders to form successive layers of plastic or thermoplastic material to construct a three-dimensional printed object with a variety of shapes and structures. After each layer of the three-dimensional printed object is formed, the plastic material is UV cured and hardens to bond the layer to an underlying layer of the three-dimensional printed object. This additive manufacturing method is distinguishable from traditional object-forming techniques, which mostly rely on the removal of material from a work piece by a subtractive process, such as cutting or drilling.

Some 3D object printers have been developed that eject drops of melted metal from one or more ejectors to form 3D objects. These printers have a source of solid metal, such as a roll of wire or pellets, that feeds solid metal into a heated receptacle of a vessel in the printer where the solid metal is melted and the melted metal fills the receptacle. The receptacle is made of non-conductive material around which an electrical wire is wrapped to form a coil. An electrical current is passed through the coil to produce an electromagnetic field that causes the meniscus of the melted metal at a nozzle of the receptacle to separate from the melted metal within the receptacle and be propelled from the nozzle. A build platform is positioned to receive the ejected melted metal drops from the nozzle of the ejector and this platform is moved in a X-Y plane parallel to the plane of the platform by a controller operating actuators. These ejected metal drops form metal layers of an object on the platform and another actuator is operated by the controller to alter the distance between the ejector and the platform to maintain an appropriate distance between the ejector and the most recently printed layer of the metal object being formed. This type of metal drop ejecting printer is also known as a magnetohydrodynamic (MHD) printer.

During the process of constructing a metal object with a MHD printer, the previously formed layer acts as a support for the next printed layer. If the next layer extends beyond the perimeter of the previous layer and the extension or step-out of the next layer, as it sometimes called, is relatively small, the part forms correctly. If the step-out is relatively large, however, the material in the extension falls to the substrate and fails to form the part correctly. Even when the step-out does not extend a distance that causes the material to drop, the overhanging feature may droop. To address this issue, support structures are commonly built to support the extensions during manufacture of the object and then these supports are removed from the object. In polymer additive manufacturing, these supports can either be easily broken away by hand, or dissolved in a solvent.

Such is not the case with metal drop ejecting systems. If the melted metal used to form objects with the printer is also used to form support structures, then the support structure bonds strongly with the features of the object that need support while they solidify. Consequently, a significant amount of cutting, machining, and polishing is needed to remove the supports from the object. Coordinating another metal drop ejecting printer using a different metal is difficult because the thermal conditions for the different metals can affect the build environments of the two printers. For example, a support structure metal having a higher melting temperature can weaken or soften the metal forming the object or a support metal structure having a lower melting temperature than the object can weaken when the object feature made with the melted metal at the higher temperature contacts the support structure. Additionally, hollow internal cavities, such as channels and curved through-holes, also pose a challenge to print as tooling needs to reach the support material used to support the walls of these cavities to remove it. Being able to form support structures that enable metal drop ejecting printers to form metal object overhangs, other extending features, and internal cavities without adversely affecting the build environment would be beneficial.

### SUMMARY

A new method of operating a 3D metal object printer builds support structures that adequately support object features during manufacture but can be removed from the completed metal object without damaging the object. The method includes applying a borate solution containing silica particles to a surface and operating an ejector head to eject melted metal drops onto the surface to which the borate solution has been applied.

A new 3D metal object printer builds silica support structures that adequately support object features during manufacture but can be removed from the completed metal object without damaging the object. The new 3D metal object printer includes an ejector head having a vessel with a receptacle within the vessel that is configured to hold melted metal and eject melted metal drops, a planar member, and an applicator that applies a borate solution containing silica particles to a surface onto which melted metal drops are ejected.

### BRIEF DESCRIPTION OF THE DRAWINGS

The foregoing aspects and other features of a method for operating a 3D metal object printer that builds support structures that adequately support object features during manufacture but can be removed from the completed metal object without damaging the object and a 3D metal object printer that implements the method are explained in the following description, taken in connection with the accompanying drawings.

FIG. 1 depicts a new 3D metal object printer that applies a borate solution containing silica particles to at least one surface so the surface can be removed from the completed metal object without damaging the object.

FIG. 2 is a schematic diagram of a chemical process that occurs when a surface to which borate solution with silica particles has been applied and melted metal drops interact with the surface.

FIG. 3 is a flow diagram of a process for operating the system of FIG. 1 that builds support structures that adequately support object features during manufacture but can be removed from the completed metal object without damaging the object.

FIG. 4 is a schematic diagram of a prior art 3D metal printer that builds support structures with melted metal drops.

### DETAILED DESCRIPTION

For a general understanding of the environment for the 3D metal object printer and its operation as disclosed herein as well as the details for the printer and its operation, reference is made to the drawings. In the drawings, like reference numerals designate like elements.

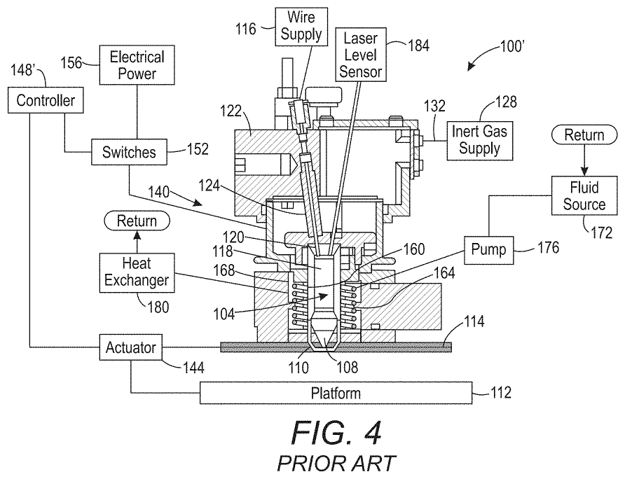

FIG. 4 illustrates an embodiment of a previously known 3D metal object printer 100 that ejects drops of a melted metal to form both a metal object and the support structures that enable features, such as overhangs or internal cavities, to be formed. In the printer of FIG. 4, drops of melted bulk metal are ejected from a receptacle of a removable vessel 104 having a single nozzle 108 and drops from the nozzle form a base layer of an object with swaths applied directly to a build platform 112. As used in this document, the term “removable vessel” means a hollow container having a receptacle configured to hold a liquid or solid substance and the container as a whole is configured for installation and removal in a 3D metal object printer. As used in this document, the term “vessel” means a hollow container having a receptacle configured to hold a liquid or solid substance that may be configured for installation and removal from a 3D object metal printer. As used in this document, the term “bulk metal” means conductive metal available in aggregate form, such as wire of a commonly available gauge, pellets of macro-sized proportions, and metal powder.

With further reference to FIG. 4, a source of bulk metal 116, such as metal wire 120, is fed into a wire guide 124 that extends through the upper housing 122 in the ejector head 140 and melted in the receptacle of the removable vessel 104 to provide melted metal for ejection from the nozzle 108 through an orifice 110 in a baseplate 114 of the ejector head 140. As used in this document, the term “nozzle” means an orifice fluidically connected to a volume within a receptacle of a vessel containing melted metal that is configured for the expulsion of melted metal drops from the receptacle within the vessel. As used in this document, the term “ejector head” means the housing and components of a 3D metal object printer that melt, eject, and regulate the ejection of melted metal drops for the production of metal objects. A melted metal level sensor 184 includes a laser and a reflective sensor. The reflection of the laser off the melted metal level is detected by the reflective sensor, which generates a signal indicative of the distance to the melted metal level. The controller receives this signal and determines the level of the volume of melted metal in the removable vessel 104 so it can be maintained at an appropriate level 118 in the receptacle of the removable vessel. The removable vessel 104 slides into the heater 160 so the inside diameter of the heater contacts the removable vessel and can heat solid metal within the receptacle of the removable vessel to a temperature sufficient to melt the solid metal. As used in this document, the term “solid metal” means a metal as defined by the periodic chart of elements or alloys formed with these metals in solid rather than liquid or gaseous form. The heater is separated from the removable vessel to form a volume between the heater and the removable vessel 104. An inert gas supply 128 provides a pressure regulated source of an inert gas, such as argon, to the ejector head through a gas supply tube 132. The gas flows through the volume between the heater and the removable vessel and exits the ejector head around the nozzle 108 and the orifice 110 in the baseplate 114. This flow of inert gas proximate to the nozzle insulates the ejected drops of melted metal from the ambient air at the baseplate 114 to prevent the formation of metal oxide during the flight of the ejected drops. A gap between the nozzle and the surface on which an ejected metal drop lands is intentionally kept small enough that the inert gas exiting around the nozzle does not dissipate before the drop within this inert gas flow lands.

The ejector head 140 is movably mounted within Z-axis tracks for movement of the ejector head with respect to the platform 112. One or more actuators 144 are operatively connected to the ejector head 140 to move the ejector head along a Z-axis and are operatively connected to the platform 112 to move the platform in an X-Y plane beneath the ejector head 140. The actuators 144 are operated by a controller 148 to maintain an appropriate distance between the orifice 110 in the baseplate 114 of the ejector head 140 and a surface of an object on the platform 112. The build platform in some versions of the system 100 consists essentially of oxidized steel, while in others the oxidized steel has an upper surface coating of tungsten or nickel.

Moving the platform 112 in the X-Y plane as drops of molten metal are ejected toward the platform 112 forms a swath of melted metal drops on the object being formed. Controller 148 also operates actuators 144 to adjust the distance between the ejector head 140 and the most recently formed layer on the substrate to facilitate formation of other structures on the object. While the molten metal 3D object printer 100 is depicted in FIG. 4 as being operated in a vertical orientation, other alternative orientations can be employed. Also, while the embodiment shown in FIG. 4 has a platform that moves in an X-Y plane and the ejector head moves along the Z axis, other arrangements are possible. For example, the actuators 144 can be configured to move the ejector head 140 in the X-Y plane and along the Z axis or they can be configured to move the platform 112 in both the X-Y plane and Z-axis.

A controller 148 operates the switches 152. One switch 152 can be selectively operated by the controller to provide electrical power from source 156 to the heater 160, while another switch 152 can be selectively operated by the controller to provide electrical power from another electrical source 156 to the coil 164 for generation of the electrical field that ejects a drop from the nozzle 108. Because the heater 160 generates a great deal of heat at high temperatures, the coil 164 is positioned within a chamber 168 formed by one (circular) or more walls (rectilinear shapes) of the ejector head 140. As used in this document, the term “chamber” means a volume contained within one or more walls within a metal drop ejecting printer in which a heater, a coil, and a removable vessel of a 3D metal object printer are located. The removable vessel 104 and the heater 160 are located within such a chamber. The chamber is fluidically connected to a fluid source 172 through a pump 176 and also fluidically connected to a heat exchanger 180. As used in this document, the term “fluid source” refers to a container of a liquid having properties useful for absorbing heat. The heat exchanger 180 is connected through a return to the fluid source 172. Fluid from the source 172 flows through the chamber to absorb heat from the coil 164 and the fluid carries the absorbed heat through the exchanger 180, where the heat is removed by known methods. The cooled fluid is returned to the fluid source 172 for further use in maintaining the temperature of the coil in an appropriate operational range.

The controller 148 of the 3D metal object printer 100 requires data from external sources to control the printer for metal object manufacture. In general, a three-dimensional model or other digital data model of the object to be formed is stored in a memory operatively connected to the controller 148. The controller can selectively access the digital data model through a server or the like, a remote database in which the digital data model is stored, or a computer-readable medium in which the digital data model is stored. This three-dimensional model or other digital data model is processed by a slicer implemented with the controller to generate machine-ready instructions for execution by the controller 148 in a known manner to operate the components of the printer 100 and form the metal object corresponding to the model. The generation of the machine-ready instructions can include the production of intermediate models, such as when a CAD model of the device is converted into an STL data model, a polygonal mesh, or other intermediate representation, which in turn can be processed to generate machine instructions, such as g-code, for fabrication of the object by the printer. As used in this document, the term “machine-ready instructions” means computer language commands that are executed by a computer, microprocessor, or controller to operate components of a 3D metal object additive manufacturing system to form metal objects on the platform 112. The controller 148 executes the machine-ready instructions to control the ejection of the melted metal drops from the nozzle 108, the positioning of the platform 112, as well as maintaining the distance between the orifice 110 and a surface of the object on the platform 112.

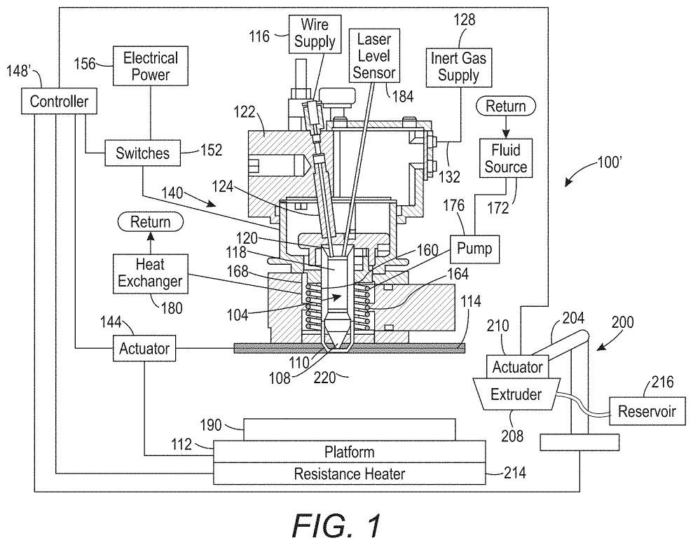

Using like reference numbers for like components and removing some of the components not used to build support structures during metal object formation, a new 3D metal object printer 100′ is shown in FIG. 1. The printer 100′ includes a borate solution application system 200 as well as a controller 148′ configured with programmed instructions stored in a non-transitory memory connected to the controller. The controller 148′ executes the programmed instructions to operate the system 200 as described below to form either support structures using a borate solution containing silica particles or apply a layer of such a borate solution to a surface of a metal support so both types of support structures can be easily removed after object manufacture is complete.

The printer embodiment shown in FIG. 1 has a borate solution application system 200 that includes an articulated arm 204 that is configured to maneuver an extruder 208 in three-dimensional (3D) space above the build platform 112. In the embodiment shown in FIG. 1, the extruder 208 is connected through a hose 216 to a reservoir 220 that contains a borate solution having silica particles suspended in the solution. The extruder 208 is operatively connected to an actuator 210 that drives a displacement member, such as a plunger or lead screw, to expel the borate solution from the extruder. The controller 148′ operates the actuator 210 selectively to expel the borate solution from the extruder.

In one embodiment, the reservoir 212 contains a borate solution, such as sodium tetraborate dissolved in an appropriate solvent, such as water, ethylene glycol, propylene glycol, or the like with silica particles suspended in the solution. When the solution is heated, the solvent evaporates and the bulk silica particles bind together to form a glassy layer. The term “silica particles” means sand, silica gel, clay, fumed silica, or the like. The borate solution can include a surfactant, such as sodium dodecyl sulfate, for wetting. As used in this document, the term “borate solution” means a solution made by dissolving a conjugate borate salt in an aqueous or nonaqueous solvent and dispersing silica particles in the solution. The solid particle size of the silica material and the packing in the uncured mixture stored in the reservoir 212 is sufficiently porous to tolerate rapid solvent loss at high printing temperatures while maintaining the mechanical integrity of the support structure made from the material. The particles in the silicate solution have an average diameter in the range of about 50 nanometers to about 250 microns but particles having an average diameter in the range of about 10 microns to about 250 microns form more robust support structures.

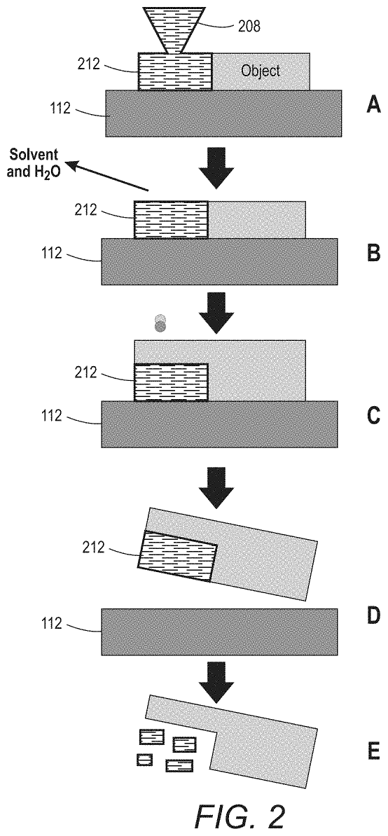

The process that occurs during application of the borate solution to a metal support structure or during the building of a silica support structure and the reaction of a metal object feature with the silica layer is shown in FIG. 2. To start this process, the articulated arm 204 is operated by the controller 148′ to move the extruder 208 above the build platform and extrude one or more layers of the borate solution on either a support structure formed with melted metal drops ejected from the extruder 208 or to form a layered support structure 212 along with object layers. Step A, FIG. 2. The controller 148′ delays a predetermined time so the heat in the build environment generated by the resistance heater 214 and the melted metal drops ejected from the extruder 208 to evaporate the solvent and water from the borate solution layers of the support structure or the upper borate solution layer applied to a surface of a metal support structure so the silica particulate matter of the support structure or the upper surface fuse together to become an insoluble, glassy layer. Step B, FIG. 2. The predetermined delay period is empirically determined for each type of metal used to form objects since different metals are kept at different temperatures for metal drop ejection and object formation. In one embodiment, the printer build environment is in a temperature range of about 400° C. to about 500° C. range as the heater 214 is configured to maintain the heat of the build platform in a range of about 400° C. to about 450° C. range and the melted aluminum or aluminum alloy drops have a temperature above 660° C. As the controller 148′ operates the extruder 208 to form the object layers that include the object feature supported by the support structure 212, the melted aluminum drops encounter the glassy layer of the support structure, reactively wet the layer, and bond to the silica layer through a partial redox reaction. Step C, FIG. 2. After manufacture of the metal object, the resistance heater 214 is deactivated so the object and platform can cool to a temperature of about 500° C. or less. In this temperature range, the object and the support structure can be mechanically separated from the build platform without damage to the object. Step D, FIG. 2. Any silica layers still adhering to the object feature after removal of the support structure and object from the build platform 112 can be removed with a solvent, such as water or the like, or light mechanical action. Step E, FIG. 2.

In the system and method described with reference to FIG. 1 and FIG. 2, the surface made of the fused silica particles promotes melted aluminum wetting and adhesion with the melted aluminum used to build the object feature. The adhesion of the brittle, fused silica particles of the support structure to the aluminum object feature enables the object to be removed from the support structure without damaging the object.

The controller 148′ can be implemented with one or more general or specialized programmable processors that execute programmed instructions. The instructions and data required to perform the programmed functions can be stored in memory associated with the processors or controllers. The processors, their memories, and interface circuitry configure the controllers to perform the operations previously described as well as those described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits. During metal object formation, image data for a structure to be produced are sent to the processor or processors for controller 148′ from either a scanning system or an online or work station connection for processing and generation of the signals that operate the components of the printer 100′ to form an object on the platform 112.

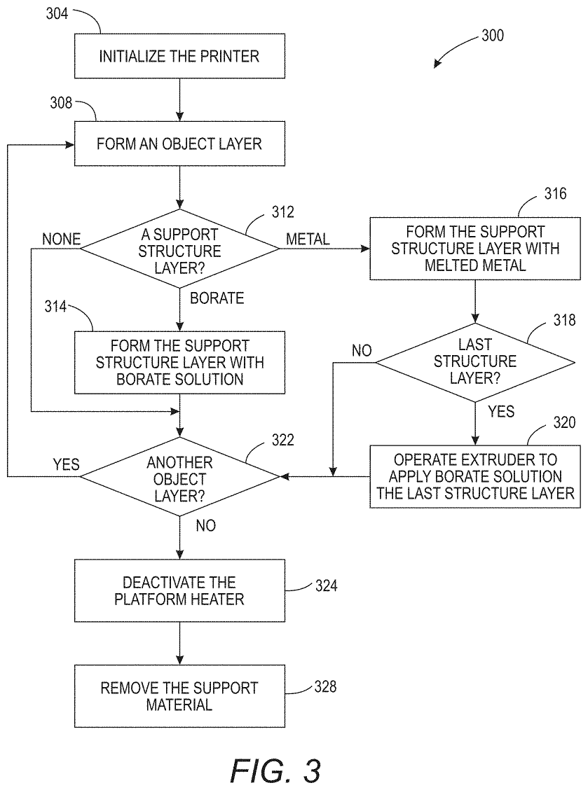

A process 300 for operating the 3D metal object printer 100′ to form support structures with borate solution layers containing silica particles on the build platform 112 or to apply such a borate solution to metal support structures is shown in FIG. 3. In the description of the process, statements that the process is performing some task or function refers to a controller or general purpose processor executing programmed instructions stored in non-transitory computer readable storage media operatively connected to the controller or processor to manipulate data or to operate one or more components in the printer to perform the task or function. The controller 148′ noted above can be such a controller or processor. Alternatively, the controller can be implemented with more than one processor and associated circuitry and components, each of which is configured to form one or more tasks or functions described herein. Additionally, the steps of the method may be performed in any feasible chronological order, regardless of the order shown in the figures or the order in which the processing is described.

FIG. 3 is a flow diagram for a process 300 that operates the borate solution application system 200 to either form a support structure with borate solution layers containing silica particles or apply a layer of such a borate solution to a surface of a metal support structure before formation of a metal object feature that is supported by either type of structure. The controller 148′ is configured to execute programmed instructions stored in a non-transitory memory operatively connected to the controller to operate the system 200 for this purpose. After the printer is initialized (block 304), the extruder is operated to form an object layer (block 308) and the process determines if a support structure layer is to be printed and the type of support that is being formed (block 312). In response to detection of a support layer made with a borate solution containing silica particles, the extruder 208 is moved into position above the build platform to form a layer of a support structure with borate solution (block 314). If the support structure is to be formed with the melted metal, then the ejector head 140 is operated to form the metal support structure layer (block 316) and the process determines if the recently formed layer of the metal support is the last one (block 318). If it is, then the extruder 208 is operated to apply a layer of borate solution containing silica particles to the last layer of the metal support structure (block 320). After a support layer is formed or if no support layer was detected, the process determines if another object layer is to be printed (block 322). The process of printing object layers and support structure layers continues until no more object layers remain to be printed. At that point, the heaters in the printer are deactivated (block 324) and the object and build platform cools to a temperature in the range of about 25° C. to about 500° C. range so the object and the portion of the brittle silica particle layer can be mechanically separated from the build platform without damaging the object (block 328). If channels were formed using the borate solution containing silica particles to support the channel walls during object formation, then the fused silica particles can be removed using an appropriate solvent, such as water or the like.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A metal drop ejecting apparatus comprising:
an ejector head having a vessel with a receptacle within the vessel that is configured to hold melted metal and eject drops of melted metal;
a planar member; and
an applicator configured to apply a borate solution containing silica particles to a surface.

2. The apparatus of claim 1 further comprising:
an articulated arm to which the applicator is operatively connected;
a reservoir configured to hold a volume of the borate solution containing silica particles;
a conduit configured to connect fluidly the reservoir to the applicator; and
a controller operatively connected to the articulated arm, the controller being configured to:
operate the articulated arm to move the applicator in a three-dimensional (3D) space over the planar member to apply the borate solution containing silica particles to the surface.

3. The apparatus of claim 2, the extruder further comprising:
an actuator configured to expel the borate solution containing silica particles from the extruder.

4. The apparatus of claim 3 wherein the actuator is configured to drive a plunger.

5. The apparatus of claim 3 wherein the actuator is configured to drive a lead screw.

6. The apparatus of claim 2, the controller being further configured to:
operate the ejector head to eject melted metal drops to form layers of a support structure;
operate the articulated arm and the extruder to apply the layer of the borate solution to a surface of the support structure formed with the melted metal drops; and
operate the ejector head to eject melted metal drops onto the layer of the borate solution on the surface of the support structure.

7. The apparatus of claim 6, the controller being further configured to:
delay a predetermined period of time before operating the ejector head to eject melted metal drops onto the layer of the borate solution.

8. The apparatus of claim 2, the controller being further configured to:
operate the articulated arm and the extruder to form layers of a support structure with the borate solution; and
operate the ejector head to eject melted metal drops on the support structure formed with the borate solution.

9. The apparatus of claim 8, the controller being further configured to:
delay a predetermined period of time before operating the ejector head to eject melted metal drops onto the support structure formed with the layers of the borate solution.

10. The apparatus of claim 2, the controller being further configured to:
operate the extruder to form a layer of the borate solution on the planar member.

11. A method of operating a metal drop ejecting apparatus comprising:
operating an applicator to apply a borate solution containing silica particles to a surface; and
operating an ejector head to eject melted metal drops onto the applied borate solution containing silica particles.

12. The method of claim 11 further comprising:
operating an articulated arm to move the applicator in a three-dimensional (3D) space over a planar member to apply the borate solution containing silica particles to the surface.

13. The method of claim 12 further comprising:
operating an actuator to expel the borate solution containing silica particles from the extruder.

14. The method of claim 13 wherein the operation of the actuator drives a plunger to expel the borate solution containing silica particles.

15. The method of claim 13 wherein the operation of the actuator drives a lead screw to expel the borate solution containing silica particles.

16. The method of claim 12 further comprising:
operating the ejector head to eject melted metal drops to form layers of a support structure;
operating the articulated arm and the extruder to apply the layer of the borate solution containing silica particles to a surface of the support structure formed with the melted metal drops; and
operating the ejector head to eject melted metal drops onto the layer of the borate solution containing silica particles on the surface of the support structure.

17. The method of claim 16 further comprising:
delaying a predetermined period of time before operating the ejector head to eject melted metal drops onto the layer of the borate solution containing silica particles.

18. The method of claim 12 further comprising:
operating the articulated arm and the extruder to form layers of a support structure with the borate solution containing silica particles; and
operating the ejector head to eject melted metal drops on the support structure formed with the borate solution containing silica particles.

19. The method of claim 18 further comprising:
delaying a predetermined period of time before operating the ejector head to eject melted metal drops onto the support structure formed with the layers of the borate solution containing silica particles.

20. The method of claim 12 further comprising:
operating the extruder to form a layer of the borate solution containing silica particles on the planar member.
